(19) United States
(12) Patent Application Publication
(10) Pub. No.: US 2011/0142208 A1
(43) Pub. Date: Jun. 16, 2011

(54) INTERACTIVE ANSWERING SYSTEM AND METHOD

(75) Inventor: LAWRENCE E. ANDERSON, ARLINGTON, VA (US)

(73) Assignee: LAWRENCE ANDERSON, ARLINGTON, VA (US)

(21) Appl. No.: 12/964,703

(22) Filed: Dec. 9, 2010

Related U.S. Application Data
(60) Provisional application No. 61/283,870, filed on Dec. 10, 2009.

(51) Int. Cl. H04M 1/64; H04M 15/06

(52) U.S. Cl. 379/88.01; 379/142.04

(57) ABSTRACT

An answering system and method comprising a caller ID input; an outgoing message output; a memory for storage of a plurality of messages; a processor for selecting outgoing message; whereby the processor selects a message from memory dependent upon the caller ID input.

RELATED APPLICATION DATA

This application is a nonprovisional application of Provisional Application No. 61/283,870 filed Dec. 10, 2009, to which priority is hereby claimed.

### FIELD OF THE INVENTION

The present invention is directed to an answering device or system and in particular to an interactive answering device or system.

### BACKGROUND OF THE INVENTION

Conventional telephone answering systems provide a single response regardless of the caller. Caller ID is available in many locations across the country for identifying the person calling the telephone. Yet, in general, the same response is provided regardless of the identity of the caller. Frequently, when an individual is away on vacation, he would like a select group of individual callers to know of his whereabouts without letting others know. For example, one might be hesitant to leave an extended absence greeting on an answering system inasmuch as thieves could call and later rob the home in the owner's absence.

### SUMMARY OF THE PRESENT INVENTION

A preferred embodiment comprises an answering system assembly comprising a caller ID component, incoming message recording and storage capability, outgoing message recording and storage capability and a controller or central processing unit. An incoming caller ID number (box 21) is first identified to determine whether the caller is an individual known to the recipient or is a person within a particular category, such as, for example, solicitors or sales people (see FIG. 2, box 22). The identification of the person in box 22 is inputted into a channel selection component (23), and the outgoing message selector (25) selects an outgoing message from memory storage 26 for playback by the answering system (box 27). The outgoing messages may be stored in an outgoing message memory as shown in FIG. 3. The outgoing message may be inputted or changes using either a remote telephone (33) or the answering system input microphone (box 34). A telephone key pad (or the like) may be used to select a location in storage for the outgoing message. For example, the assembly may be preprogrammed so that channel 1 is used for the operator's husband; channel 2 is used for the son, and so on. The correlation between the channel selected for the husband and the husband office telephone and cell phone number are stored in memory. When the caller ID recognizes the number of the husband's cell or office phone number, the outgoing message recorded specifically for the husband is selected by the play back message selector 37 and outputted by the answering system output controller 38 represented by outgoing message output (box 56, FIG. 6).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which: The drawings of this invention are illustrative and diagrammatic in nature in order to present the principles of the invention. They are being provided as examples without limiting the invention to the specific configuration or dimensions shown.

FIG. 1 is a schematic illustration comprising selective components of an answering system 10.

FIG. 2 is a schematic illustration illustrating the utilization of caller ID input to select or change an outgoing message.

FIG. 3 is a schematic illustration diagrammatically illustrating outgoing message storage memory 26.

FIG. 4 is a diagrammatic illustration showing the inputting of an outgoing message in accordance with a preferred embodiment of the present invention.

FIG. 5 is a schematic illustration showing a message inputted and stored as an outgoing message in accordance with a preferred embodiment of the present invention.

FIG. 6 is a schematic illustration showing the selection of an outgoing message based upon an incoming caller ID.

FIG. 7 is a schematic illustration of an exemplary layout of a preferred embodiment hand held telephone.

FIG. 8 is a schematic illustration of an exemplary layout of a preferred embodiment answering machine base.

### DETAILED DESCRIPTION OF PREFERRED EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

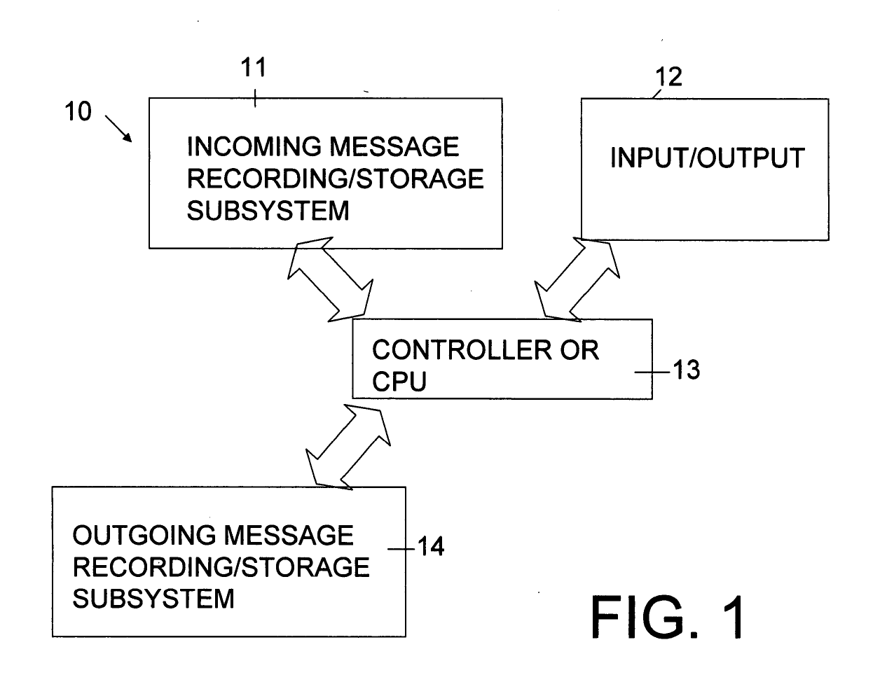

FIG. 1 is a schematic illustration comprising selective components of an answering system 10. The illustration is merely exemplary. The principles of the present invention may be utilized in connection with any type answering system or device and is not limited to answering systems or telephone systems. Instead of an answering system, the invention could be utilized in a computerized system which responds to telephone calls when the person to whom the call is placed is not present. Although individual components or elements are shown in FIGS. 1 through 6, the principles of the present invention could be implemented by software. For example, a computerized system such as that used to answer cell phones which is remote to the cell phone user could be modified through software to function in accordance with the principles of the present invention. Moreover, the invention is not limited to telephone usage as individualized messages could be sent to email participants in response to emails from a particular person or category of persons. As used herein, the term person refers to a person, company, organization, or group of persons.

As shown in FIG. 1, a preferred embodiment comprises an answering system assembly 10 comprising a caller ID component, incoming message recording and storage subsystem 11, an outgoing message recording and storage subsystem 14 and a controller or central processing unit 13 and input/output 12. Although individual boxes are used to show elements 11 through 14, the elements could be combined in a variety of ways or located in a single component without departing from the principles of the present invention. For example, a computerized phone system could be utilized, such as that used to respond to cell phone callers, which implements the incoming and outgoing message recording and storage subsystems in a singular system, which may or may not be combined with an input/output system.

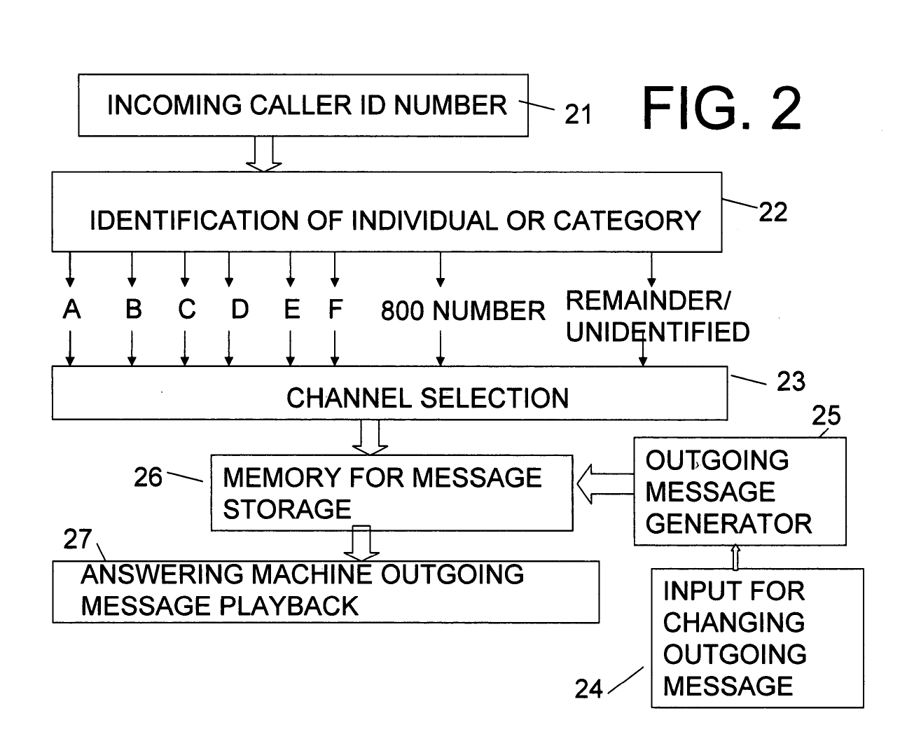

As shown in FIG. 2, an incoming caller ID number (box 21) is first identified to determine whether the caller is an individual known to the recipient or is a person within a particular category, such as, for example, solicitors or sales people (see FIG. 2, box 22). The identification of the person in box 22 is inputted into a channel selection component (23), and the outgoing message selector or generator (25) selects an outgoing message from memory storage 26 for playback by the answering system (box 27).

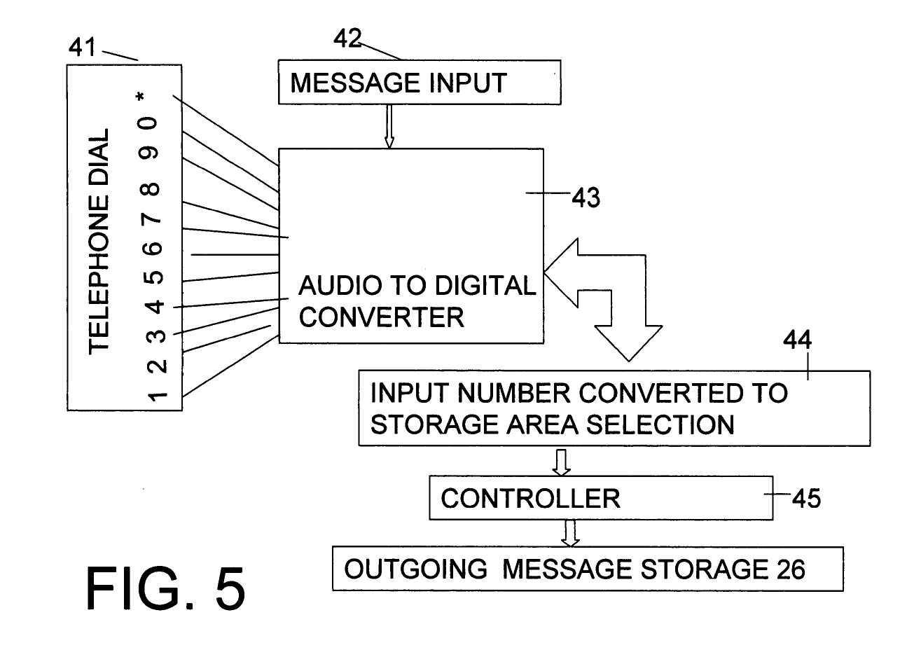

Box 24 of FIG. 2 represents the changing of the outgoing message via input from the person being called. For example, consider the situation when the person being called is a wife who wants the husband to pick up a loaf of bread that evening. The husband is arbitrarily given channel 1. If the wife is at a remote location, then she may utilize a telephone dial to select the channel 1 as illustrated schematically in FIG. 5. As an example, the wife calls the answering system and inputs a code to change the outgoing message; similar to the code commonly inputted to review stored messages. The wife selects channel 1 and records a message for the husband, such as “pick up a loaf of bread.” The husband cell phone number and/or office telephone number are stored in memory (not shown) and previously programmed so as to be correlated to channel 1. When the husband calls, the caller-ID will identify the husband's cell or office phone number and the answering system will play the outgoing message inputted by the wife, such as “pick up a loaf of bread.” As an optional feature, when the husband is not using his cell phone or office phone, the answering system could be coded such that when the husband inputs a code; he receives the message “pick up a loaf of bread.” As a further example, the caller-ID component may determine that the caller is a solicitor or salesperson. The caller-ID function may be preprogrammed such that solicitors correlate to channel 9 and solicitors receive a message in the storage area reserved for channel 9, such as “if you are soliciting, selling merchandise, or announcing the winner of a contest, please identify yourself in full by name, address, the company you represent, and phone number.” Or the message may be “if you are soliciting, selling merchandise, or announcing the winner of a contest, we do not accept such solicitations. Please remove our number from your calling list.”

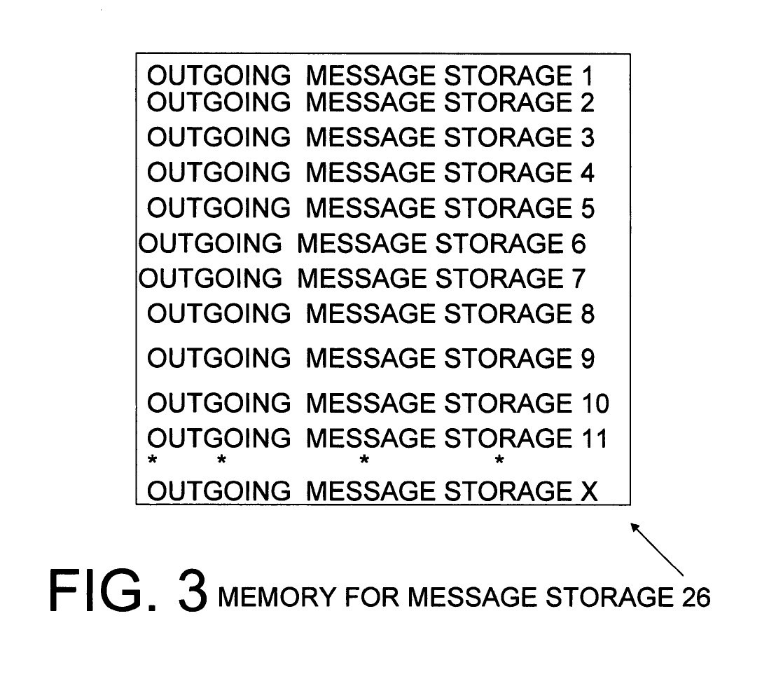

The outgoing messages may be stored in an outgoing message memory as shown diagrammatically in FIG. 3. Each channel may correspond to a respective area of memory.

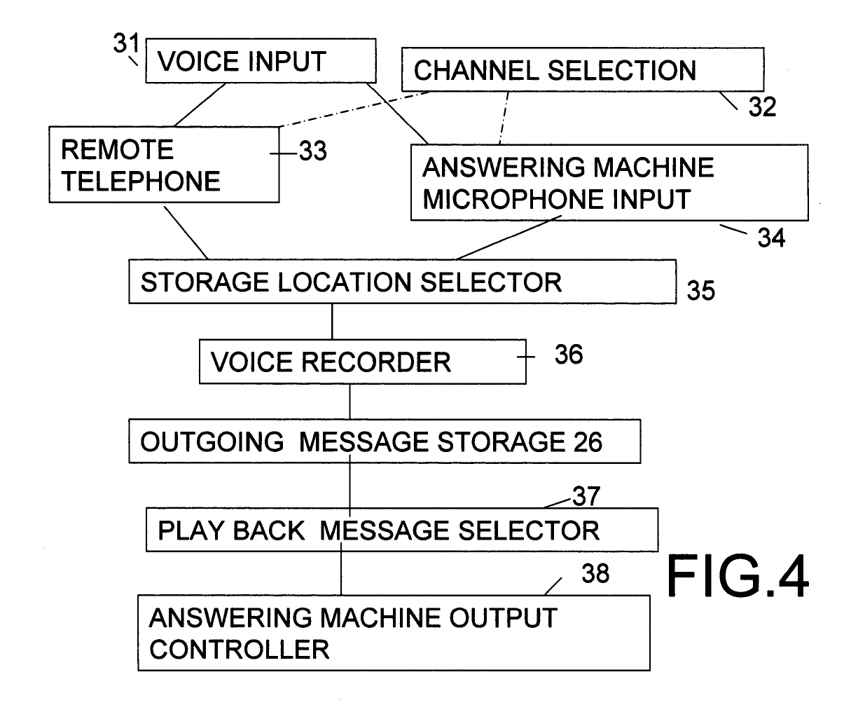

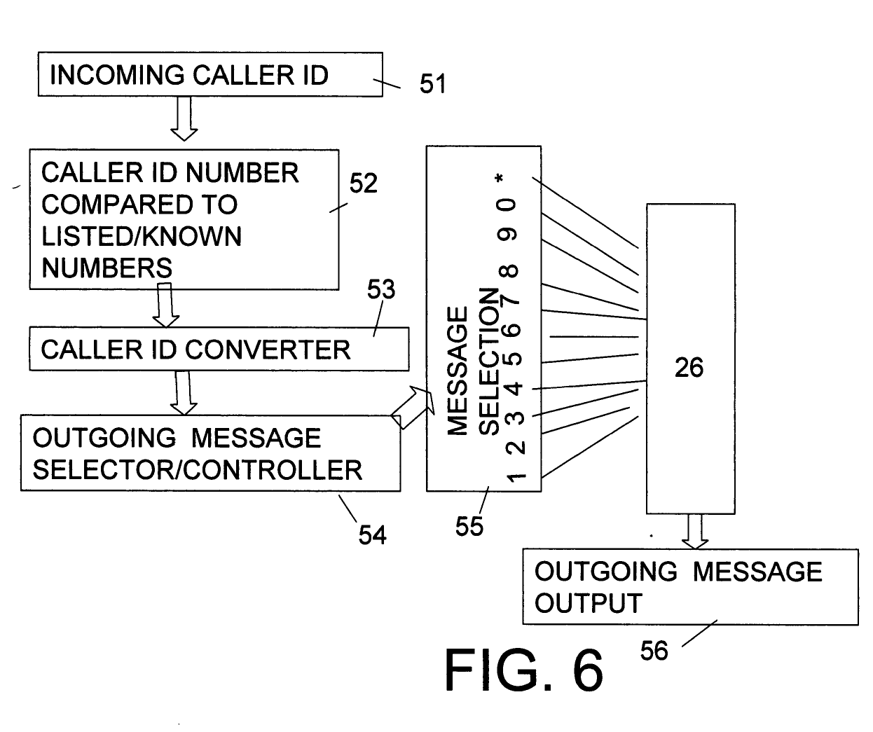

As shown in FIG. 4, the outgoing message may be inputted or changed using either a remote telephone (33) or the answering system input microphone (box 34). A telephone key pad (or the like) may be used to select a location in storage for the outgoing message. For example, the assembly may be preprogrammed so that channel 1 is used for the operator's husband, channel 2 is used for the son, and so on. The correlation between the channel selected for the husband and the husband office telephone and cell phone number are stored in memory. When the caller ID recognizes the number of the husband's cell or office phone number, the outgoing message recorded specifically for the husband is selected by the play back message selector 37 and outputted by the answering system output controller 38 represented by outgoing message output (box 56, FIG. 6).

As shown further in FIG. 4, a storage location selector (35) may be used in conjunction with a voice recorder (36) to select the location in memory 26 that the person inputting the message has designated for a particular caller or callers. The voice recorder (36) may comprise an analog to digital converted to store inputted voice messages in digital format. When the particular caller or callers' telephone number is identified by the incoming caller ID (box 51), the play back message selector 37 outputs the appropriate message via answering machine controller 38. The answering machine controller may be a processor, computer, microprocessor, controller or the like.

As illustrated in FIG. 5, in accordance with a preferred embodiment, the telephone dial (see box 41) may be used to select the channel of the outgoing message when the operator is calling from a remote location using a telephone to change the outgoing message of the answering machine system 10. From the remote telephone receiver (not shown), the message is inputted at box 42 and converted from analog to digital (as represented by box 43 in a manner well known to those skilled in the art. For example, the caller will input into the answering system using a code or identifier to change the outgoing message via voice or the telephone dial as represented by box 41. Optionally voice recognition equipment may be used and the caller may simply state “change outgoing message” and select the individual or group of individuals for whom the outgoing message is intended. For example, the wife may instruct via voice recognition software to change the outgoing message for my husband to say “pick up loaf of bread.” The voice recognition software will automatically change the storage location corresponding to the husband's outgoing message and store the message in the appropriate location in memory. In conjunction with the caller ID, the channel will be correlated with telephone numbers of phone frequently used by the husband. Alternately, a code may be required before the husband receives the message as an additional security measure.

As shown in FIG. 5, the number inputted via the phone dial is used to select the channel and storage location as represented by box 44.

As shown in FIG. 6, an incoming caller ID subassembly retrieves the phone number of the caller as represented by box 51. In cases where the caller may block the caller ID, the answering machine may be programmed to output an outgoing message to the effect that “this answering system will not record messages in cases where the caller ID has been block intentionally. Please call back using a phone where the caller ID is not blocked.”

As shown in FIG. 6, the caller ID is converted (as represented by box 53) and a selection is completed to choose an outgoing message (as represented by boxes 54, 55) so that the outgoing message output 56 outputs a message retrieved from memory which the operator wants the identified caller to receive.

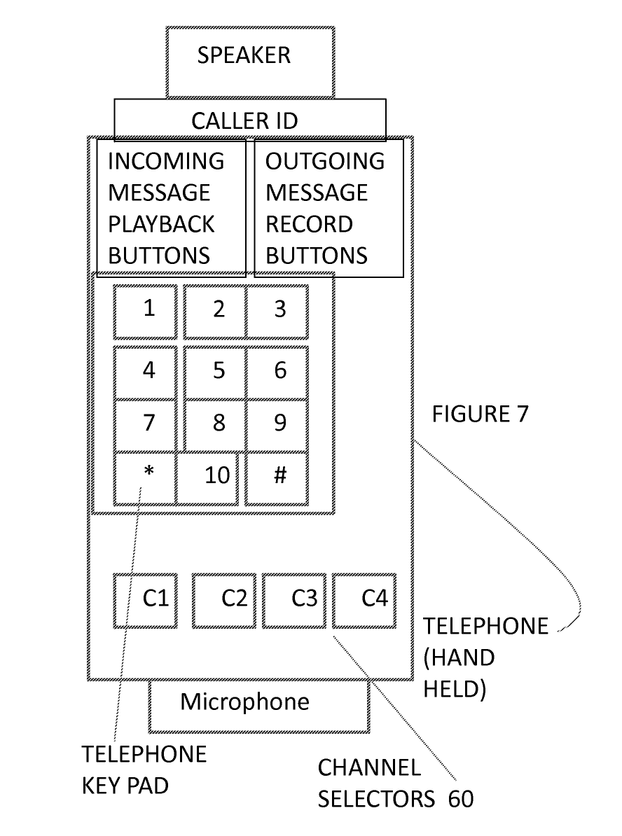

FIG. 7 is a schematic illustration of an exemplary layout of a preferred embodiment hand held telephone. The hand held telephone includes the standard telephone key pad. In addition, channel keys 60 (or message selection inputs) are positioned thereon for channel selection. The channel selectors may, for example, be push buttons or pads which respond to touch of a finger. The channel selector may be used to select the playback channel for storage of an outgoing message. The outgoing messages may be stored in an outgoing message memory as shown diagrammatically in FIG. 3.

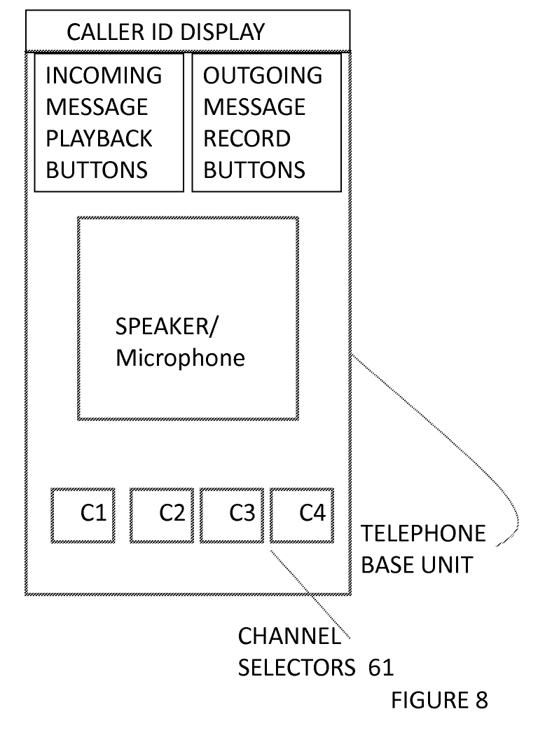

FIG. 8 is a schematic illustration of an exemplary layout of a preferred embodiment answering machine base. The telephone base includes channel keys 61 (or message selection inputs) positioned thereon for channel selection. The channel selectors may, for example, be push buttons or pads which respond to touch of a finger. The channel selector may be used to select the playback channel for storage of an outgoing message. The outgoing messages may be stored in an outgoing message memory as shown diagrammatically in FIG. 3.

The terminology controller as used herein may be a microprocessor, computer, programmable controller, programmable chip, processor or the like.

The terminology processor as used herein means a microprocessor, microprocessors, computer, computers, programmable controller or controllers, personal computer, programmable chip, multiprocessor, coprocessor, minicomputer, main frame, CPU, combinations thereof, or the like.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

1. A system for responding to phone calls comprising:
an input for receiving information identifying the phone number of the incoming call;
a variable outgoing message output;
a memory for storing prerecorded outgoing messages;
a selector for selecting the outgoing message from the memory depending upon the identification of the incoming call.

2. The system of claim 1 further comprising an outgoing message input; the outgoing message input operatively connected to receive incoming calls, whereby an outgoing message may be inputted remotely by calling the phone number associated with the system.

3. The system of claim 1 further comprising a microphone for inputting outgoing messages.

4. The system of claim 1 wherein the selector comprises a plurality of channels, each channel having a corresponding outgoing message, and whereby the channel is selected depending upon the identification of an incoming call.

5. The system of claim 4 wherein a plurality of incoming phone numbers are associated with a predetermined channel.

6. The system of claim 1 wherein the location in memory of an outgoing message may be specified by entering at least one number using a telephone key pad.

7. The system of claim 1 wherein a channel may be preselected for at least one predetermined individual.

8. The system of claim 1 wherein when the incoming caller inputs a predetermined code, a predetermined outgoing message is outputted.

9. The system of claim 1 wherein the system is programmed to determine whether or not the incoming call is a solicitation and the outgoing messages requests that the caller identify him or herself and remove the recipient's name from the caller's list.

10. The system of claim 1 further including a voice recognition unit whereby the outgoing message is changed by the recognition of a predetermined voice.

11. The system of claim 1 wherein the caller is identified using voice recognition software and the selector selects an outgoing message depending upon the caller identified by the voice recognition software.

12. The system of claim 1 wherein an outgoing call for a predetermined caller is inputted using a first of a plurality of inputs on the base of a commercial answering machine such that an input is selected, a message is inputted and the telephone key pad is used to input the caller's number; whereby upon receiving a call from the number, the message inputted will be heard, and subsequently, when it is desired to change the outgoing message for that caller ID, the first input is pressed and a new message is recorded

13. The system of claim 1 further comprising a series of outgoing message inputs on the base of the telephone answering machine, whereby predetermined outgoing messages are associated with incoming telephone numbers using the outgoing message inputs.

14. An answering system comprising:
a caller ID input;
an outgoing message output;
a memory for storage of a plurality of messages;
an outgoing message selector;
whereby the outgoing message selector selects a message from memory dependent upon the caller ID input.

15. On a processor controlled answering system, a method for answering telephone calls comprising:
recording a plurality of outgoing messages into memory; each of the messages being directed to a select individual or group of individuals; each of the outgoing messages set up to be played in response to the calling of a single phone number;
upon receipt of an incoming call, using the processor, determining a caller ID identifying the incoming caller;
using the processor, determining whether the incoming caller ID is associated with an outgoing message in memory;
using the processor, selecting one of a plurality of outgoing messages for playback depending upon the caller ID input;
playing the outgoing message to the caller.

16. The method of claim 15 wherein the selecting step comprises selecting an outgoing message using an outgoing message selector.

17. The method of claim 16 wherein the outgoing message selector selects a message from memory dependent upon the caller ID input.

18. The method of claim 15 wherein an outgoing message may be inputted remotely by calling the phone number associated therewith.

19. The method of claim 15 wherein an outgoing message may be inputted using a microphone in conjunction with channel selection inputs.

20. The method of claim 15 wherein the entire answering system is embedded in the base of a standard home telephone.
